(19) United States
(12) Patent Application Publication
(10) Pub. No.: US 2002/0105546 A1
(43) Pub. Date: Aug. 8, 2002

(54) Browser container for hypertext application

(75) Inventor: George Ralph Kuntz, Denville, NJ (US)

Correspondence Address: DARBY & DARBY P.C., 805 Third Avenue, New York, NY, 10022, US

(73) Assignee: Hamilton Scientific, Ltd.

(21) Appl. No.: 10/025,117

(22) Filed: Dec. 19, 2001

Related U.S. Application Data
(60) Provisional application No. 60/258,895, filed on Dec. 28, 2000.

(51) Int. Cl. G09G 5/00

(52) U.S. Cl. 345/762

(57) ABSTRACT

This invention relates to a method and system for activating a function at a station in an application operating on a hypertext document. The hypertext document contains control elements. Each control element has a set of attributes. The method involves parsing the attributes of the control element, sending the attributes to an object module associated with this control element, and invoking the object module to make a GUI object containing the attributes. Once the system invokes the object module, the object module associated with a particular control element is activated. The activated object module then displays the GUI object.

### CROSS-REFERENCE TO RELATED APPLICATIONS

This application claims the benefit of priority from provisional U.S. Patent Application, Serial No. 60/258,895 entitled “Browser Container For Hypertext Application,” filed Dec. 28, 2000, the disclosure of which is incorporated herein by reference in its entirety.

### BACKGROUND OF THE INVENTION

1. Field of the Invention

The invention relates generally to the field of hypertext browser programming. More particularly, the invention relates to a computer-implemented system and method that assists users in creating a hypertext browser template which facilitates a global hypertext change environment.

2. Description of Related Art

Computer markup languages developed in a natural evolution in the transition from typeset text to computer word processing. With a printing press, printers must annotate text with instructions for the typesetters. These instructions tell the typesetters what typeface to use and when to use special characters such as bold, italic, etc.

In 1986, the International Organization for Standardization (ISO) approved a system for the creation of new markup languages. This system was designated Standard Generalized Markup Language or SGML. SGML was a “meta-language”—a language for describing languages.

SGML was later used to develop the Hypertext Markup Language (HTML), a very simple electronic publishing language that is extensively used on the Internet. HTML describes how a web browser should display headings, text, buttons, forms and images. According to the World Wide Web Consortium (W3C), “HTML is the lingua franca for publishing hypertext on the World Wide Web. It is a non-proprietary format based upon SGML, and can be created and processed by a wide range of tools, from simple plain text editors—you type it in from scratch- to sophisticated WYSIWYG authoring tools. HTML uses tags such as <h1> and </h1> to structure text into headings, paragraphs, lists, hypertext links etc.

In many ways, HTML made the growth of the Internet possible. Its simplicity made it easy to learn and utilize. Its standardization meant that any browser would display an HTML-based web page in a similar fashion. This allowed for widespread proliferation of Internet information.

However, HTML's simplicity is also its principle weakness. Its function is limited to a method for displaying information without telling the computer or the end-user what that information represents. The HTML tags are merely display instructions rather than information about the data within them. In order to utilize the data, servers would have to continuously retrieve and resend information from and to the browser after each user intervention. This slows the interaction significantly and limits the ability to fully integrate the data efficiently.

The W3C realized that the Internet was significantly hampered by the limitations of HTML and began work on a solution in 1996. Their concept was to enable the markup language to include an extensible tag, which contained information about the data in addition to its display characteristics.

The solution was the Extensible Markup Language (XML), which the W3C released in 1998. XML was based on SGML but streamlined to focus on the need to transfer descriptive information within the tags surrounding each piece of data. XML is also a meta-language. It consists of rules that allow a program designer to create a new markup language.

Because it is standardized, XML is a universal format for transferring structured documents and data. This means that it can be used on any type of computer. XML is also easy for humans to learn and understand because its code appears as nothing more than strings of ordinary text and a few text-based controls surrounded by angle brackets. It can be utilized on a single computer or over a network, including the Internet. In particular, its universality and standardization properties make it ideal for sharing data over varying systems and languages. For this reason, it has been widely adopted as a standard for Internet data transfer.

XML functions on a set of rules that permit its internal parser to process the information the program contents. One of the rules defines that tags on data must come in pairs, surrounding the text to which they apply. These tag pairs can also be “nested” within one another like parenthesis inside a mathematical formula. This nesting allows for the creation of a “tree structure” which allows unlimited complexity of the document.

XML transmits information, including descriptions of the content, that can be rendered by an application. Different applications can render the same XML document in different ways. For example, an XML document containing a recipe could be rendered by one application into a word document that could appear as a chapter in a cookbook. A second application reading the same document could produce a shopping list for the grocery store. While a third application could translate the recipe from English measurements into Metric. Therefore, an editor application can read an XML document for display similar to HTML. Because of XML's flexibility, elements can be defined that determine the manner in which the textual data is displayed.

But, XML can also be used to define small computer languages, analogous to C, C++, Java and BASIC. Many applications allow their users to customize the applications' behaviors using a scripting language. For example, a spreadsheet may contain a simple BASIC interpreter that allows the user to customize the appearance of the spread sheet, define macros, run complex formulas, set up tables, etc.

### SUMMARY OF THE INVENTION

The present invention relates generally to a hypertext language browser template program which facilitates the creation of a global program change environment. More particularly, a preferred implementation of the present invention envisions creating a global program change environment for doctors desiring a common template setup for a shared patient database.

One embodiment of the present invention comprises a method for creating a browser template for a hypertext application for an editing user working in a global change environment. The method includes a text editor first reading a control element having a set of attributes from a hypertext file and then parsing this control element into a set of attributes. An example of a control element could include, but is not limited to, a Menu Box. An example of an attribute for this control element could include, but is not limited to, a label for this Menu Box. Once the text editor has parsed the control element by attributes, the text editor passes the parsed set of attributes to an object module. The control element determines which object module is called. The object module then creates a Graphical User Interface object (“GUI object”) of the attribute. Prior to the formation of the GUI object, the attribute is simply data represented in the computer memory. The GUI object is a visual pixel display of this data represented in the computer memory. The creation of the GUI object by the object module is well known in the art. One reference depicting this process can be found in GRADY BOOCH, OBJECT-ORIENTATED ANALYSIS AND DESIGN WITH APPLICATIONS (The Benjamin/Cummings Publishing Company 1994) which is incorporated by reference in its entirety. Once the object module has created a GUI object, the object module sends the GUI object back to the text editor. The text editor receives from the object module a GUI object of the control element.

An alternative embodiment of the present invention encompasses a method for displaying within a browser container a hypertext application for an editor user. The method includes first receiving a position location from a user interacting with an actuating device. Then, the method includes mapping this position location selection to a corresponding leaf node having a GUI object associated with the leaf node. Finally, the last step is displaying to the user a corresponding GUI object having selectable elements at the position location.

An alternative embodiment of the present invention envisions a browser template for hypertext applications represented as data to a user located on a distributed computer network at a station. This embodiment includes a template defining an arrangement of control elements to be included in a browser template as well as an object module containing information relating to a set of GUI objects of the control elements. A software engine then responds to text submitted by the user at the station by accessing a database and populating the template with a GUI object of the control element.

A further embodiment of the present invention involves a method for activating an object module in an application operating on a hypertext document at a station. The hypertext document contains at least one control element. This control element has attributes. The method includes the steps of parsing the attributes of the control element and sending the attributes to an object module associated with the control element. Once the attributes are sent, the method invokes the object module to make a GUI object containing the attributes of the control element. Once invoked, the object module is then activated and the GUI object is displayed.

A alternative embodiment of the present invention involves a method for editing text contained within an object module that is dynamically created in response to a control element in a hypertext document at a station. This method involves first parsing the control element into a set of attributes. Once the control elements are parsed, the attributes are displayed in an edit box. The attributes are editable. Then an object module corresponding to the edited attribute is located using a mapping from a location of the control element to a pointer to the object module corresponding to the edited attribute. Finally, the the edited attribute is sent to the corresponding object module.

A further embodiment involves a system for activating an object module in an application operating on a hypertext document containing a control element. This control element has attributes. The system includes a station that hosts an application that operates on a hypertext document that contains the control element having the attribute. The system further includes a server. This server receives from the station the hypertext document that contains the control element with the attribute. In addition, the server sends to the station a GUI object for display in the hypertext document. The server includes both an object module and a software engine. The object module makes a GUI object of the control element having a set of attributes. The software engine parses the control element into a set of attributes in the hypertext document. In addition, the software engine sends the attribute to the object module and invokes the object module to make a GUI object of the control element having the set of attributes.

An other embodiment of the present invention involves a system for editing a hypertext document containing a control element. The control element has an attribute. The system comprises a station that hosts an application that operates on the hypertext document and that contains the control element having the attribute. In addition, the system includes a server. The server receives from the station the hypertext document that contains a control element having at least one of an editable attribute and an edited attribute. In addition, the server sends to the station the editable attribute for display in an edit box. The server includes a set of object modules and a software engine. The set of object modules has at least one object module that makes a GUI object of the edited attribute. The server's software engine, parses the control element into a set of attributes to be edited. In addition, the software engine locates the object module corresponding to an edited attribute using a mapping from a location of the control element to a pointer to the object module corresponding to the edited attribute. Finally, the software engine sends the edited attribute to an object module corresponding to the edited attribute.

### DETAILED DESCRIPTION OF THE SUMMARY OF THE INVENTION

While the above represents the summary of the invention, the following describes with more particularity the preferred embodiments of the present invention. It is to be understood that the detailed description below is for purposes of illustration. The following detailed description does not limit the above summary of the invention.

According to one more particular aspect of the present invention, a speed enhancement to the parsing can be made to the preferred embodiment of the present invention. During the parsing phase, when the editor parses the beginning of an XML element that defines a control element (e.g., “<popup-menu . . . >”), the editor appends the label associated leaf node. The editor then adds the leaf node and the actual XML text up to and including the close control element (e.g., “</popup-menu>”) to the location hash table, without building the GUI object for the popup menu. Note that the menus and menu-items (e.g. the associated attributes) enclosed in the popup-menu are not displayed at this time.

During the user editor phase, when the user clicks on the label that appears in the edit box, the GUI object that was stored in the location hash table corresponding to the control element is activated. Alternatively, upon the click, the control element is parsed at this time and the GUI object is built. The GUI object is then displayed. The location hash table entry corresponding to the leaf node is replaced with the GUI object just created, still using the leaf node as the hash table search value. By doing this replacement, should the user again click on the same control, the GUI object can just be displayed without requiring that it be rebuilt.

Other objects and features of the present invention will become apparent from the following detailed description considered in conjunction with the accompanying drawings. It is to be understood, however, that the drawings are designed solely for the purpose of illustration and not as a definition of the invention, for which reference should be made to the appended claims.

### BRIEF DESCRIPTION OF THE DRAWINGS

The foregoing and other features of the present invention will be more readily apparent from the following detailed description and drawings of illustrative embodiments of the invention wherein like reference numbers refer to similar elements throughout the several views and in which:

FIG. 1 is an exemplary template editor Web page in accordance with the preferred embodiment;

FIG. 2 is an exemplary Web page illustrating a prompt box control element;

FIG. 3 is an exemplary Web page illustrating a pop-up menu control element;

FIG. 4 is an exemplary Web page illustrating a check-box control element;

FIG. 5 is an exemplary Web page illustrating a calendar selector control element; and, FIG. 6 is an exemplary Web page illustrating a number control element;

FIG. 7 is a template editing process;

FIG. 8 is an exemplary Pop Up Menu Module flowchart which represents a more detailed view of the creation of the GUI object as seen in FIG. 7;

FIG. 9 is an exemplary Menu Module flowchart representing the creation of a GUI object as seen in FIG. 7;

FIG. 10 is an exemplary Menu Item Module flowchart representing the creation of a GUI object as seen in FIG. 7;

FIG. 11 is an editor user's interaction with the preferred embodiment of the present invention; and

FIG. 12 is a network arrangement useful for implementing a preferred embodiment of the present invention.

### DETAILED DESCRIPTION OF THE PREFERRED EMBODIMENTS

By way of overview and introduction, a preferred embodiment of the present invention provides a software tool and technique for providing a global change environment for a hypertext application of a browser template. As used herein, “a global change environment” is an environment in which a user can access a data record for viewing or modification, or in which a system process can initiate an operation or access such data records. In particular, a preferred embodiment of the present invention provides a hypertext application where using a text editor, an object module, and a hash table, a control element in a hypertext file (including its associated attributes) is transformed into a corresponding GUI object of the control element and its associated attributes. Control elements are distinguished from prose text by being bracketed or appear in a different color. However, the present invention is not limited to distinguishing the control elements in only this fashion. In the XML file, the control elements are indicated by the appropriate hypertext flag format. The associated attributes are listed between the “open” and “close” flags of the control element. Each of the control elements operates in a similar fashion with regard to the actual programming. The following description of steps is intended to serve as an illustration of the preferred embodiment of the special function programming.

The programming for each control element is written in XML. When run by the template editor, the control element is read from the XML file during the parsing process. The template editor then checks for the type of control element as indicated by the value of the hypertext flag and retrieves the location of the corresponding object module for such hypertext flag type from a hash table. This allows the template editor to identify the element as a recognized function within the XML program and instructs the template editor on how to implement the function.

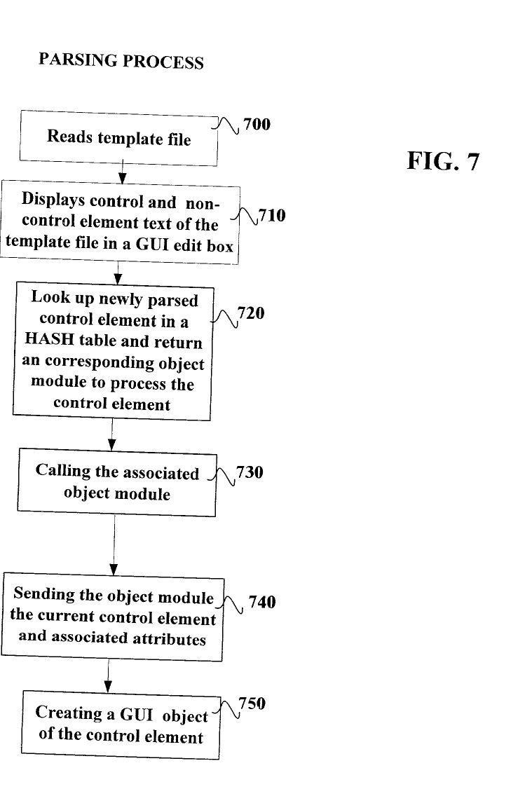

The template editor then executes the object module, passing the object module the attributes (which in the preferred embodiment, are a series of strings in the XML file following the hypertext flag) that were defined with the element in the XML file as parameters. The object module for a control element generates a GUI object corresponding to the type of control element as described below with reference to FIG. 7. A pointer to the GUI object is added to a “position” hash table indexed by the editor text position. The GUI object is also pushed onto a stack. If new sub-control elements are encountered in the XML file, (i.e., if there is nesting of control element levels corresponding to nested levels of selection menus and the like) more GUI objects are created and the attributes for such sub-elements are passed, and the new elements are pushed onto the stack. If the stack is not empty, the newly encountered sub-elements are added to the control on the top of the stack as children of the control element (e.g. menu-items to a popup-menu). Note that in the preferred embodiment Menu and Menu Item must be nested within a popup menu control element.

When the user editor user later clicks the mouse over some text in the editor text box, the editor searches the position hash table using the mouse coordinates (using the EditBox and LeafatMouseLocation). If a corresponding GUI object is found, the user editor causes the appropriate GUI object for the stored control element to become active and visible at the location of the mouse click.

The user of the editor then has the opportunity to interact with the GUI object, choosing a parameter, sub-element or function to select from the list of choices offered. Other examples include typing text into a window or selecting an active function designated by the new selection. If a sub-element is selected, it is moved onto the stack for processing. When finished with the GUI, the user editor selects an action button (usually labeled “OK”) and the object module is closed. This causes the selected element or selected sub-elements to appear on the screen interspersed with the previously displayed normal text where the highlights were located.

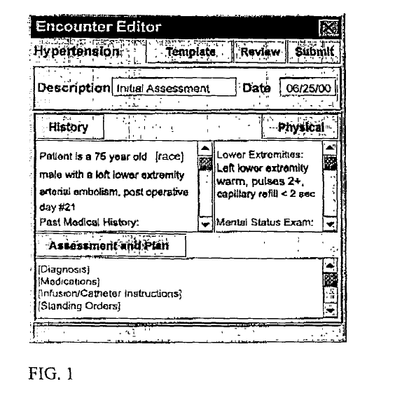

With reference now to FIG. 1, an exemplary template editor Web page in accordance with a preferred embodiment of the present invention is shown. In FIG. 1, “race” is an exemplary control element 110 . Control elements 110 are distinguished from the standard text. The control elements 110 can be distinguished by the editor user by color, font, italics or any other method which would clearly distinguish control element text 110 from non-control element text. The editor user by selecting the control element 110 “race,” using any appropriate actuating method or device (i.e. mouse click, keypad click, voice activation, pressure sensory device, etc.), sends a position location selection to a text editor. Once the text editor receives the position location selection, a corresponding GUI object having selectable elements is presented to the user. In this case, being the control element 110 is “race”, an appropriate GUI object could include, but is not limited to selectable elements such as African, Asian, and Caucasian. Once the editor user finishes editing a particular patient's record, the entire template page is sent to the host server by hitting the submit 112 button.

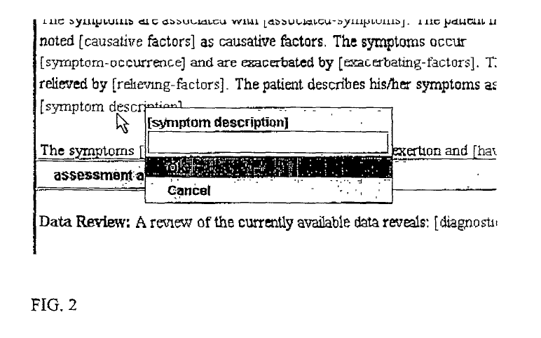

With reference now to FIG. 2, an exemplary Web page illustrating a type of control element, namely a prompt box control element 210 is displayed. Here, after the editor user clicks the control element 110, the text editor displays to the user a prompt box control element 210. Here the control element 110, prompts the user to enter a symptom description.” Upon entering the Symptom description,” the symptom text entered by the editor user replaces the control element 110 text Symptom description.”

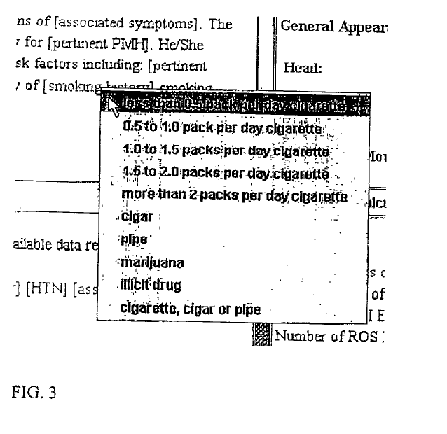

With reference now to FIG. 3, an exemplary Web page illustrating a type of control element, namely a pop-up menu control element 310 is displayed. Various control elements 110 are displayed in FIG. 3. To name just a few, “associated symptoms,” “pertinent PMH” and “smoking history” all represent control elements 110. One of the control elements 110, namely the “smoking history” control element 110 is a pop-up menu control element 310. Once the user selects the text from the pop-up menu control element 310, this text will replace the control element 110 text “smoking history.” For example, if the editor user selects “illicit drug,” the text illicit drug would replace the “smoking history” text in the body of the template.

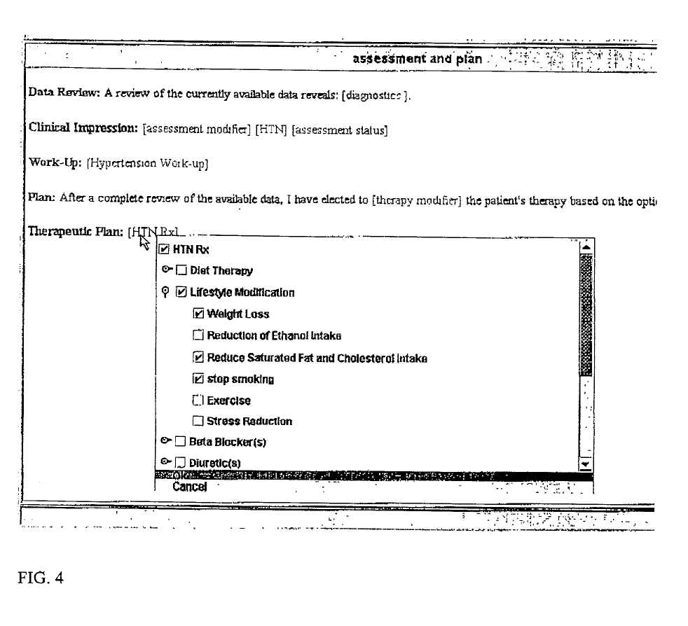

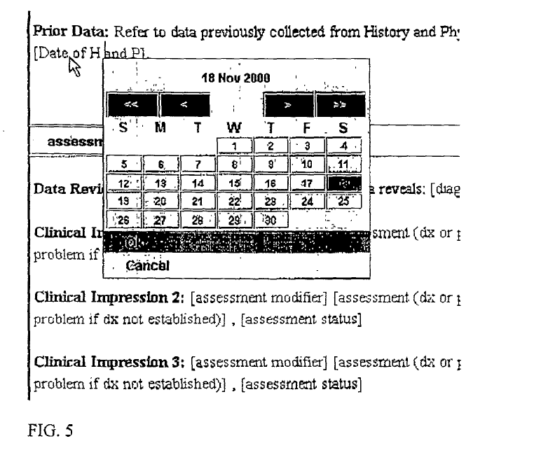

With reference now to FIG. 4, an exemplary Web page illustrating a type of control element 110, namely a check-box control 410 is displayed. As in FIGS. 2 & 3, various control elements 110 are displayed. Note that the control elements are distinguished from the standard text by bracketing the control element 110 text. Here, in FIG. 4 a different type of control element 110 is displayed. Here once an editor user clicks the control element text “HTN Rx” this check-box control 410 appears. The editor user can check as many or as few of the selections as the editor user wishes to appropriately describe the control element 110 HTN Rx, which in this case relates to a patient's “Therapeutic Plan.”

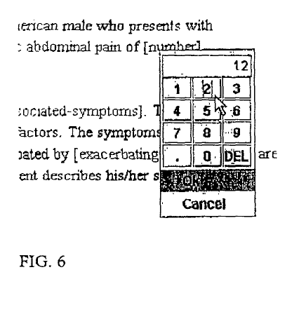

With reference now to FIG. 5, an exemplary Web page illustrating a type of control element 110, namely a calendar selector control element. Numerous control elements 110 are also represented in FIG. 5, however the featured element is the “Date of H and P” control element 110. Once the user with the actuating device selects this “Date of H and P” control element, the calendar selector control type appears 510. This calendar selector control type 510 allows the editor user to select a particular calendar date. The editor user in this example selected “Nov. 18, 2000” 512 with their user actuating device. Now that Nov. 18, 2000 has been selected, this date will replace the control element 110 text “Date of H and P.”

FIG. 6., depicts an exemplary Web page illustrating a type of control element, namely a number selector control. As in FIGS. 2-5, a different control element type is being showcased. Here a user selected the control element 110 “number” selector control element. Then the number selector control type 610 appears. The user then inputs 12 into the number selector control type box 610. The number 12 will now replace the control element 110 text once the user closes this edit box.

With reference to FIG. 7, a template editing process is shown. Step by step, the template editor converts a hypertext template file into a GUI object of the text contents of that hypertext template file. First, the template editor reads an XML template file 700 which contains both prose text, e.g. non-control elements, and editable control elements or rather editable attributes of these control elements. Once the template editor has read the XML template file 700, the template editor displays to the editor user the text contents of the XML template file in a GUI edit box 710. It should be noted that the editor user sits at a user station which is connected to a network, the network can be a distributed computer network such as the Internet or World Wide Web, or can be a WAN (“Wide Area Network”) or a LAN(“Local Area Network”). The template editor addresses the user in the conventional manner. For example, the editor user can enter the Web site URL hosted by the template editor server with a browser software package or the like. In response, the server provides over the distributed computer network a Web page on the display screen at the client-side station. Once the template editor displays the XML template file's text contents, the template editor looks up the newly parsed control element in a hash table and returns an object module to process the current control element 720. The template editor then calls the object module 730. Once the object module has been called 730, the template editor sends the object module the control element 740 including the associated attributes. Finally, the object module creates a GUI object of the control element having those attributes at step 750.

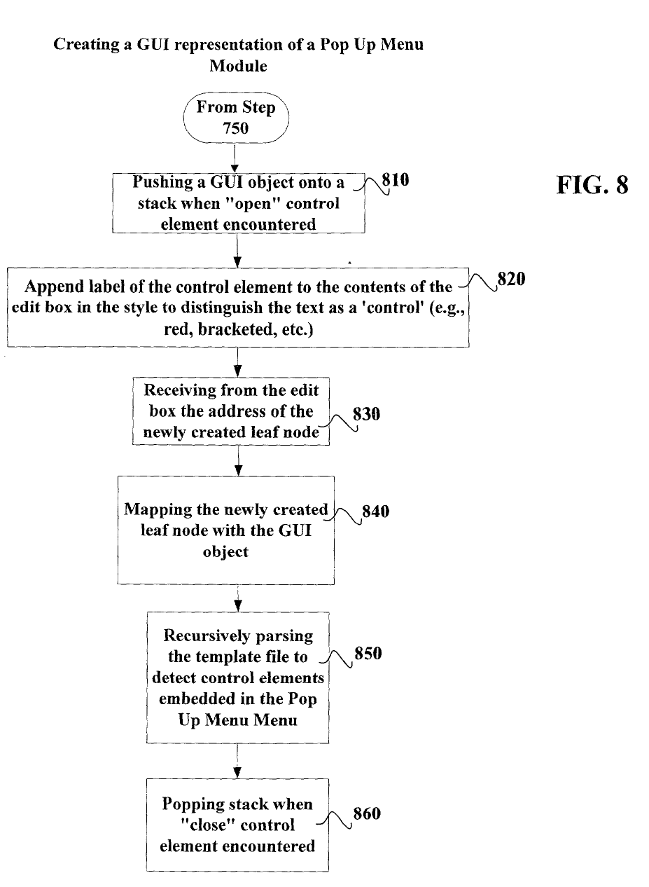

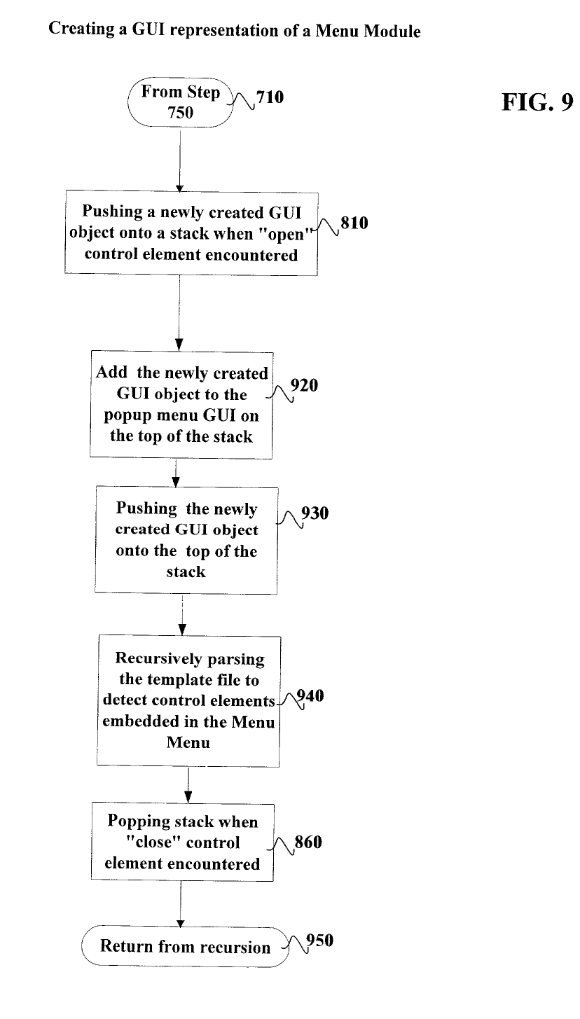

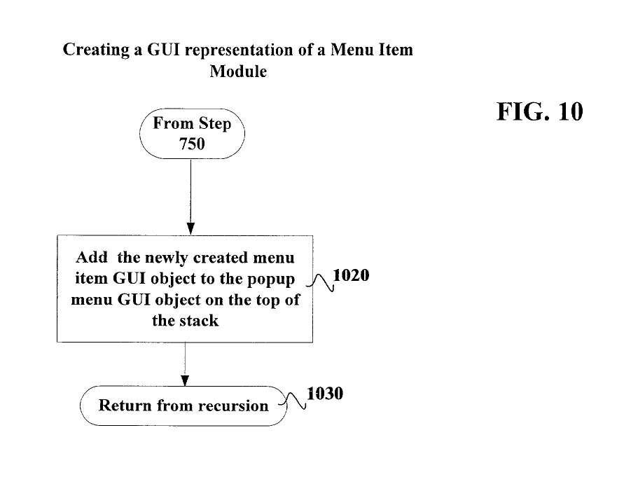

FIGS. 8-10 represents a more detailed view of the creation of the GUI object 750 as seen in FIG. 7. FIG. 8 represent an exemplary creation of a Pop Up Menu GUI object. FIG. 9 represents an exemplary creation of a Menu GUI object. FIG. 10 represents an exemplary creation of a Menu Item GUI object. The particular representation created depends on the type of control element that has been encountered at step 720 and governs the further process flow that creates the GUI object. Thus for example, the process flow after step 750 can continue with one of the process flows shown in FIGS. 8-10.

In order to create a GUI object 750 for a Pop Up Menu Module as seen in FIG. 8, first a newly created GUI object is pushed onto a stack 810. The “pushing” occurs when an “open” element is encountered. Once the GUI object has been pushed 810, then a label is appended to the contents of the edit box 820. Next an address of a newly created leaf node is received from the edit box 830. Pointers are then created and added to both the newly created leaf node and the new entry in the “location” hash table 840. This process recursively continues 850 until a “close” element is encountered in the XML file. At this point, the stack is popped 860.

The object module creates a GUI object 750 for a Menu Module as seen in FIG. 9 using a method similar to the creation of Pop Up Menu process as seen in FIG. 8. First, just as with the Pop Up Menu the object module pushes a newly created GUI object onto a stack when an “open” element is encountered 810. Then the newly created GUI object is added to the Pop Up Menu GUI on the top of the stack 920. Next, the object module pushes the newly created Menu GUI object to the top of the stack 930. At this point the object module continuously and recursively parses the XML template file 940 until the “close” element is encountered and the stack is popped 860.

Finally, the creation of a GUI object of a Menu Item Module is displayed in FIG. 10. The object module adds the newly created Menu Item GUI object to the GUI object (which is either a popup-menu or a menu) on the top of the stack 1020.

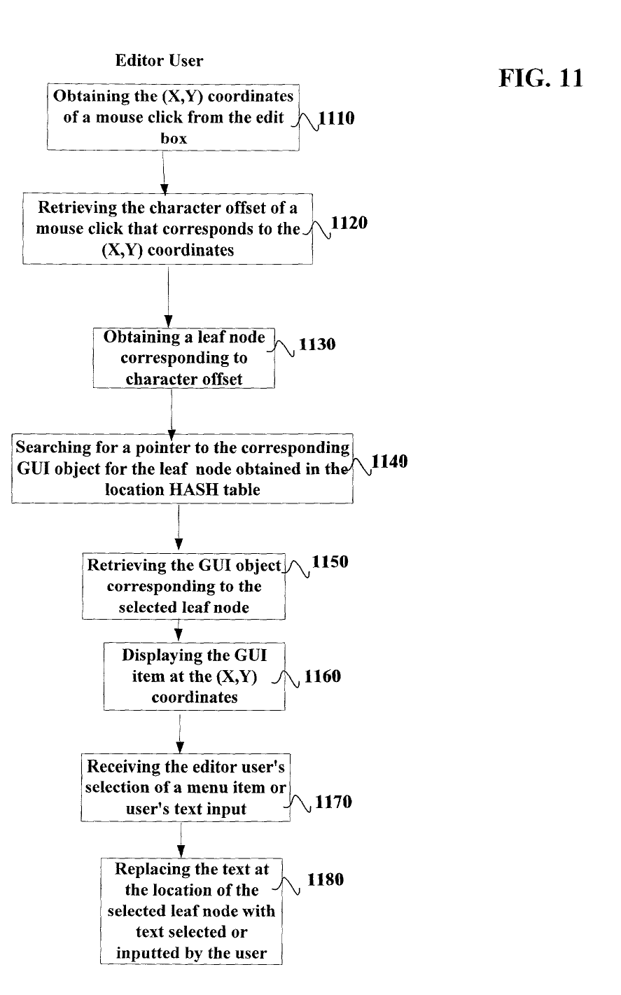

FIG. 11 discloses the editor user's interaction with the preferred embodiment of the present invention. First, the template editor receives the (X,Y) coordinates obtained from a mouse click or other such user actuating device 1110. Upon receiving the (X,Y) coordinates, the template editor retrieves the character offset that corresponds to the (X,Y) coordinates 1120. Next, a leaf node corresponding to the character offset is obtained 1130. The template editor then searches for a pointer for a leaf node obtained in the hash table 1140. Then, a GUI object is retrieved for the selected leaf node 1150. Next, the GUI object is displayed at the (X,Y) coordinates determined by the user actuating device 1160. The editor user then selects a menu item 1170. Finally, the text at the location of the selected leaf node is replaced by the editor user's submission 1180.

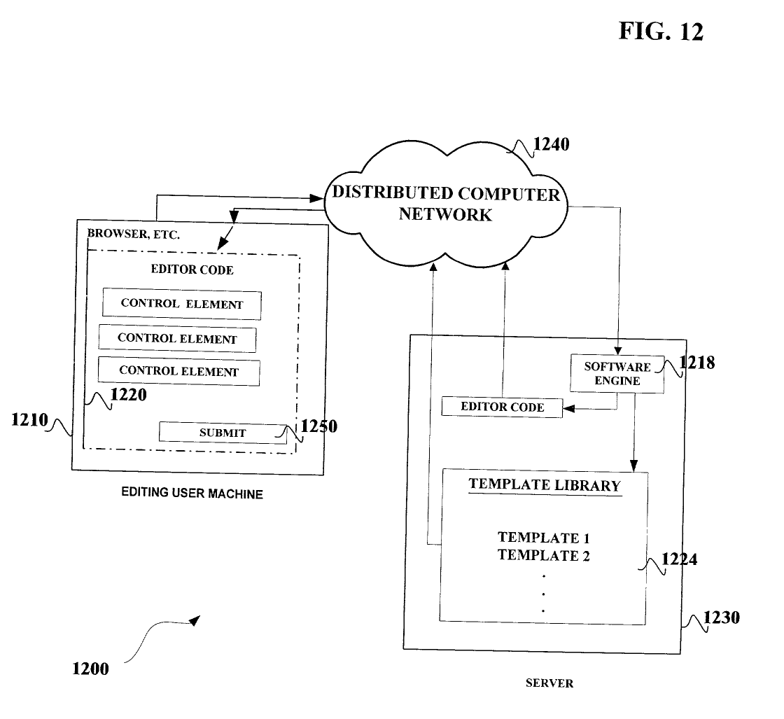

FIG. 12 is a network arrangement useful for implementing a preferred embodiment of the present invention. The network arrangement 1200 activates an object module in an application operating on a hypertext document containing control elements 110. These control elements 110 have editable attributes. A software engine 1218, on a server 1230 parses the attributes in the hypertext document. An editing user sitting at an editing user machine 1210 or a station actuates the control elements 110 and their associated attributes using an actuating device. The editing user then sends an edited template 1220 containing the edited attributes across a distributed computer network 1240 to the server 1230. At the server 1230, the text selected and submitted or simple submitted 1250 by the user or, in other words, the edited attributes are sent to a software engine 1218 at the server 1230. The software engine 1218 sends the edited attributes to the object module 1224 corresponding to the control elements 110, invokes the object module 1224 to make a GUI object containing those edited attributes, and activates the object module 1224 associated with the control element 110. The object module 1224 then populates GUI objects into a template which is sent back through the distributed computer network 1240 and displayed to the user sitting at the editing user machine 1210.

While the present invention has been described with respect to a particularly preferred embodiment, the invention is susceptible to implementation in other ways that are within the spirit of the invention which is defined in terms of the recitations of the appended claims and equivalents thereof.

I claim:

1. A method for creating a GUI object for a hypertext application at a station, which comprises, the steps of:
reading a control element from a hypertext file;
parsing the control element into a set of attributes;
passing the parsed set of attributes to an object module; and,
receiving from the object module a GUI object of the control element.

2. A method as in claim 1 wherein the GUI object received contains the set of attributes.

3. A method as in claim 1 wherein the parsing step, further comprises, the following steps:
receiving a coordinate of the control element from an actuating device; and
determining a character offset of the coordinate of the control element.

4. A method as in claim 3 wherein the parsing step, further comprises, the steps of:
receiving a text font characteristic of the control element; and
organizing a leaf node for the text font characteristic of the control element.

5. A method as in claim 4 wherein the parsing step, further comprises, the step of indexing a pointer for the coordinate and the leaf node.

6. A method as in claim 5 wherein the parsing step, further comprises, the step of creating a leaf node for the parsed control element.

7. A method as in claim 1 which further comprises the steps of:
receiving from a text parser the parsed set of attributes corresponding to the control element; and
creating a GUI object of the control element using the parsed set of attributes.

8. A method as in claim 1, wherein the control element comprises a prompt box control.

9. A method as in claim 1, wherein the control element comprises a pop-up menu control.

10. A method as in claim 1, wherein the control element comprises a checkbox control.

11. A method as in claim 1, wherein the control element comprises a calendar selector control.

12. A method as in claim 1, wherein the control element comprises a number selector control.

13. A method for displaying within a browser container a GUI object for a user, comprising, the steps of:
receiving a position location from an actuating device implemented by the user at a station;
mapping the position location to a corresponding leaf node having a GUI object associated with the leaf node; and,
displaying the GUI object to the user at the position location.

14. A method as in claim 13, wherein the station is connected across a distributed computer network.

15. A browser template for hypertext applications represented as data to a user located at a station, comprising:
a template defining an arrangement of control elements to be included in the browser template;
an object module containing information relating to a set of GUI objects of the control elements; and
a software engine which responds to text submitted by the user at the station by accessing a database and populating the editing template with a GUI object of the control element.

16. A method for activating an object module in an application operating on a hypertext document containing a control element, the control element having attributes, at a station which comprises the steps of:
parsing the attributes of the control element;
sending the attributes to an object module associated with the control element;
invoking the object module to make a GUI object containing the attributes;
activating the object module associated with the control element; and
displaying the GUI object.

17. The method as in claim 16, the sending step, which further comprises, the step of:
selecting a type of object module using a type of the control element.

18. The method as in claim 17, wherein a user activating an actuating device at a screen position corresponding to the control element incites the invoking, activating and displaying steps.

19. The method as in claim 17, wherein the control element has a corresponding displayed text label and an actuating device initiates the invoking, activating and displaying steps by a user activating the corresponding displayed text label.

20. The method as in claim 16 further comprising the step of activating a function corresponding to a type of object module invoked.

21. The method as in claim 20 wherein the function provides a user a selection of alternative inputs to the application.

22. The method as in claim 16, 17 or 18 wherein a mapping indexes a screen location of the parsed control element with a pointer to a corresponding object module.

23. A method as claimed in claim 16, 17 or 18, wherein each control element has a corresponding text label, which further comprises, the step of permitting a user to replace the corresponding control text element label with text typed in a GUI window.

24. A method as claimed in claim 16, 17 or 18, wherein each control element has a corresponding text label, which further comprises, the step of permitting a user to replace the corresponding control element label with text items selected from a set of displayed text items within a GUI window.

25. The method as claimed in claim 24, wherein the displayed text items are attributes of the control element.

26. A method as claimed in claims 16, 17 or 18, wherein each control element has a corresponding text label which further comprises, the step of permitting a user to replace the corresponding control element label with items selected within a list of items using check boxes.

27. A method as claimed in claims 16, 17 or 18, wherein each control element has a corresponding text label, which further comprises, the step of permitting a user to replace the corresponding control element label with the item selected from a pop-up menu.

28. A method for editing text contained within an object module that is dynamically created in response to a control element in a hypertext document at a station, which comprises the steps of:
parsing the control element into a set of attributes;
displaying in an edit box an attribute, the attribute being editable, from the parsing step;
locating an object module corresponding to the edited attribute using a mapping from a location of the control element to a pointer to the object module corresponding to the edited attribute; and,
sending the edited attribute to the corresponding object module.

29. The method as in claim 16, wherein a mapping indexes a screen location of the parsed control element with a pointer to the corresponding object module.

30. A method as in claim 16, 17 or 18, wherein an attribute of a control element is a control element.

31. A method as in claim 30, which further comprises the steps of:
pushing the object module onto a stack; and
parsing the control element, the control element being the attribute of the control element corresponding to the pushed object module.

32. The method as in claim 30, wherein a mapping indexes a screen location of the parsed control element with a pointer to its corresponding object module.

33. A method as in claim 16 wherein the parsing step, further comprises, the following steps:
receiving a coordinate of the control element from an actuating device; and,
determining a character offset of the coordinate of the control element.

34. A method as in claim 17, wherein the object module comprises a prompt box control.

35. A method as in claim 17, wherein the object module comprises a pop-up menu control.

36. A method as in claim 17, wherein the object module comprises a checkbox control.

37. A method as in claim 17, wherein the object module comprises a calendar selector control.

38. A method as in claim 17, wherein the object module comprises a number selector control.

39. A system for activating an object module in an application operating on a hypertext document containing a control element, the control element having attributes, comprising:
a station, the station hosts an application that operates on a hypertext document that contains a control element having an attribute;
a server, the server receives from the station the hypertext document that contains the control element having the attribute and sends to the station a GUI object for display in the hypertext document, the server having
an object module, the object module makes a GUI object of the attribute; and,
a software engine, the software engine parses the control element having the attribute in the hypertext document, sends the attribute to the object module, and invokes the object module to make the GUI object of the attribute.

40. A system for editing a hypertext document containing a control element, the control element having an attribute, comprising:
a station, the station hosts an application that operates on the hypertext that contains the control element having the attribute;
a server, the server receives from the station the hypertext document that contains a control element having at least one of an editable attribute and an edited attribute and sends to the station the editable attribute for display in an edit box, the server having
a set of object modules, at least one object module, makes a GUI object of the edited attribute; and,
a software engine, the software engine parses the control element into a set of attributes to be edited, locates the object module corresponding to an edited attribute using a mapping from a location of the control element to a pointer to the object module corresponding to the edited attribute, and sends the edited attribute to the corresponding object module.
